(19) United States
(12) Patent Application Publication
(10) Pub. No.: US 2019/0105957 A1
(43) Pub. Date: Apr. 11, 2019

(54) TOP MOUNT ASSEMBLY FOR COUNTERBALANCING STATIC LOAD

(71) Applicant: ClearMotion, Inc., Billerica, MA (US)

(72) Inventors: Joseph Thomas Belter, Somerville, MA (US); Zachary Edward Butner, Atlanta, GA (US); Matthew Jo Taylor, Kenilworth (GB)

(73) Assignee: ClearMotion, Inc., Billerica, MA (US)

(21) Appl. No.: 16/153,560

(22) Filed: Oct. 5, 2018

Related U.S. Application Data
(60) Provisional application No. 62/569,072, filed on Oct. 6, 2017.

(51) Int. Cl. B60G 13/00; B60G 17/00

(52) U.S. Cl. CPC B60G 13/003; B60G 2204/128; B60G 17/00

(57) ABSTRACT

A pressurized top mount assembly is described wherein a pressurized fluid volume receives an end of a piston rod and is configured to counteract a net static force on a top mount by a suspension component which may be an active suspension actuator, a passive suspension damper or a semi active suspension damper. The pressurized fluid volume may be in fluid communication with one or more of fluid volumes in the suspension component.

### RELATED APPLICATIONS

This application claims the benefit under 35 U.S.C. § 119(e) of U.S. provisional application Ser. No. 62/569,072, filed Oct. 6, 2017, the disclosure of which is incorporated by reference in its entirety.

### SUMMARY

In one embodiment, a pressurized top mount for a vehicle, with a bracket configured to be attached to the body of the vehicle, is disclosed that comprises: a chamber attached to one of the body or the bracket, configured to slidably receive an end of a piston rod of a suspension component, and a pressurized fluid volume contained in the chamber, configured to apply a force to the end of the piston rod.

### BACKGROUND

Modern vehicles generally include a suspension system that couples a body of the vehicle to one or more wheels of the vehicle. The suspension system may attach to the vehicle body via a set of top mount assemblies that are located near each wheel of the vehicle. As active suspension systems become commercially viable, there is a need for top mounts designed to be compatible with such active suspension systems.

### BRIEF DESCRIPTION OF THE DRAWINGS

FIG. 1 illustrates a top mount as is known in the art.

FIG. 2 illustrates a graph of force versus displacement for a typical top mount.

FIG. 3 illustrates a suspension component, with a piston, piston rod, and two fluid volumes.

FIG. 4 illustrates an exemplary embodiment of the disclosed top mount.

FIG. 5 illustrates an exemplary embodiment of the disclosed top mount, with fluid communication between the pressurized chamber and the accumulator.

FIG. 6A illustrates a front view of an exemplary embodiment of a top mount.

FIG. 6B illustrates a bottom view of the exemplary embodiment of a top mount.

FIG. 6C illustrates an isometric view of the exemplary embodiment of a top mount.

FIG. 6D illustrates a section view of the exemplary embodiment of a top mount.

FIG. 6E illustrates an exploded view of the exemplary embodiment of a top mount.

### DETAILED DESCRIPTION

In a suspended vehicle, a top mount assembly may be utilized to physically attach a body of the vehicle to a rod (e.g., a piston rod) of a suspension component of the vehicle. In an active suspension system, the suspension component may be a hydraulic actuator; while in a passive suspension system, the suspension component may be a hydraulic damper. The inventors have recognized that in an active suspension system that includes a hydraulic actuator, under static conditions the hydraulic actuator may apply static forces to the top mount assembly that greatly exceed static forces conventionally associated with a damper of a passive suspension system. In an active suspension system, these static forces may approach or even exceed the designed operating limits for the top mount assembly. As a result, top mount assemblies that perform well in passive suspension systems may suffer from significant performance degradation when utilized in active suspension systems. The inventors have recognized that, for active suspension systems, performance of the top mount assembly (and, therefore, performance of the overall suspension system) may be augmented by counter-balancing the static forces applied by the hydraulic actuator. For example, in certain embodiments, a fluid-filled volume may be located such that fluid in the volume applies a force to the rod of the hydraulic actuator that partially or fully balances the static forces associated with the hydraulic actuator.

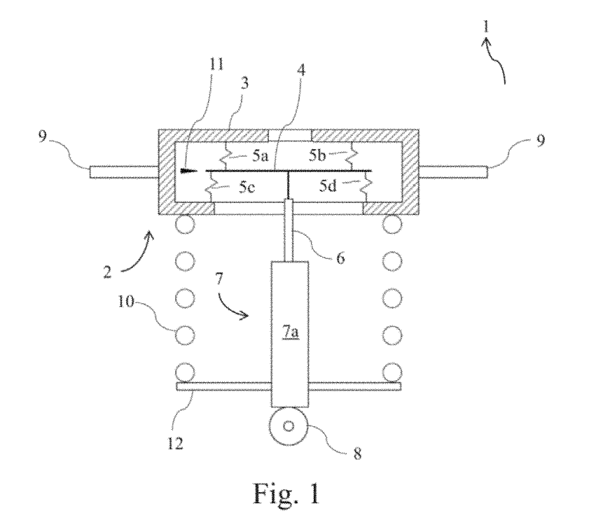

FIG. 1 illustrates an exemplary top mount assembly. In certain embodiments, the top mount assembly 2 may include a bracket 3 configured to attach to the vehicle body 9, and a strike plate 4 configured to attach to the rod 6 of the suspension component 7, which may be a hydraulic actuator of an active suspension system or a hydraulic damper of a passive suspension system. The top mount assembly may further incorporate a set of one or more spring elements 5a-d interposed between the strike plate 4 and an inner surface of the bracket 3. Each of the spring elements 5a-5d may apply a force to the strike plate 4. In certain embodiments, each of the spring elements 5a-d may be a physically distinct spring, such as a coil spring. In other embodiments, each of the spring elements 5a-d may be part of a single piece, or multiple pieces, of elastomeric (e.g., rubber or other polymeric) material. In certain embodiments, the elastomeric material may be molded onto the strike plate 4.

Spring constants of each of the spring elements 5a-d may be combined using equations known in the art to determine a single, combined spring constant. For example, a set of n spring elements oriented in a parallel arrangement may be characterized by a single combined spring element using the equation k_{combined}=k₁+k₂+k₃+ . . . +kₙ, where k_{combined} represents the combined spring constant and k₁, k₂, k₃, kₙ represent a respective spring constant of spring elements 1, 2, 3, and n. Likewise, a set of n spring elements oriented in a series arrangement may be characterized by a single combined spring element using the equation (k_{combined})⁻¹=(k₁)⁻¹+(k₂)⁻¹+(k₃)⁻¹ . . . +(kₙ)⁻¹. As would be recognized by one of ordinary skill in the art, these equations may be modified appropriately such that any set of spring elements oriented in any manner may be characterized by a single combined spring constant and/or a combined compliance. In certain embodiments, a combined spring constant and/or a combined compliance provided by the set of spring elements 5a-d may be tuned to attenuate transmission of noise and/or high frequency vibrations (e.g. generated by road excitation) from the wheel 8 to the vehicle body 9 and/or cabin.

A “neutral position” 11 of the strike plate 4 refers to the position of the strike plate 4, relative to the bracket 3, when the combined force applied by the set of spring elements 5a-d is equal in magnitude and opposite in direction to the weight of the strike plate 4. The strike plate may be in its neutral position 11 when either (a) the rod 6 is not attached to the top mount assembly, or (b) the rod 6 is attached but does not apply any force to the strike plate 4. A force applied by the rod 6 onto the strike plate 4 may cause a position of the strike plate 4 to vary relative to its neutral position 11, thereby causing compression or extension of certain spring elements 5a-5d.

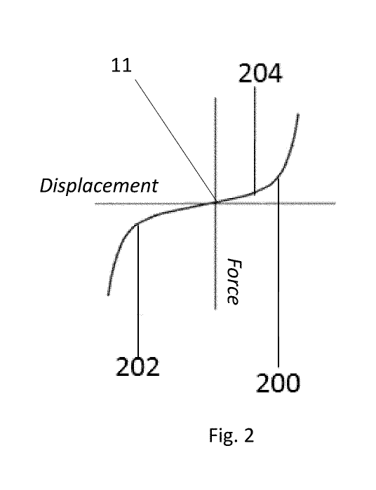

In certain embodiments, the combined spring constant provided by the set of spring elements may progressively increase as the strike plate 4 is increasingly displaced relative to its neutral position 11. An example of such behavior is shown in FIG. 2. As can be seen from the force displacement curve of FIG. 2, when the strike plate is near its neutral position 11 (e.g., zero displacement, or the origin of the curve of FIG. 2), the combined spring constant—given by the slope or derivative of the curve shown in FIG. 2—is relatively low. Upon displacement of the strike plate (relative to its neutral position) in a first direction beyond a threshold value 202 and/or displacement of the strike plate (relative to its neutral position) in a second direction beyond a threshold value 200, the combined spring constant may begin to significantly increase. Such behavior may be utilized to limit a range of motion experienced by the strike plate.

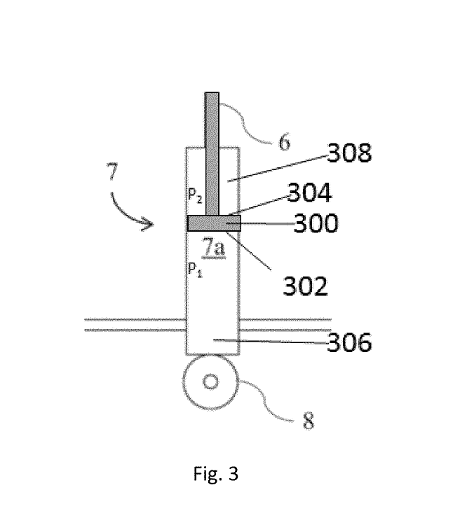

FIG. 3 illustrates an exemplary suspension component 7, that may be, for example, a hydraulic damper and/or hydraulic actuator. The suspension component 7 may include a piston 300 having a first surface 302 and a second surface 304 that is opposite the first surface 302. As shown in FIG. 3, the first surface 302 or a portion thereof may partially define a first fluid filled volume 306, while the second surface 304 or a portion thereof may partially define a second fluid filled volume 308. The suspension component 7 may further include a piston rod 6 that is attached to the piston 300. In certain embodiments, the first fluid filled volume 306 may be in fluid communication with the second fluid filled volume 308 via one or more fluidic channels (not shown). The one or more fluidic channels may pass through the piston 300. Various valves and/or restrictions may be located along the one or more fluidic channels. In active suspension systems, the suspension component may be a hydraulic actuator that includes a pump (not shown) that controllably varies a pressure difference between the first pressure P₁ and the second pressure P₂.

The first surface 302 of the piston may be exposed to fluid having a first pressure (designated P₁), while the second surface 304 of the piston may be exposed to fluid having a second pressure. Due to the piston rod 6, a first area (denoted A₁ herein) of the first surface 302 that is exposed to fluid in the first volume 306 may be greater than a second area (denoted A₂ herein) of the second surface 304 that is exposed to fluid in the second volume 308. Since force is equal to the product of pressure times area (i.e., F=P*A), fluid in the first volume 306 applies a first force (designated F₁) to the first surface 302 of the piston; this first force has a magnitude equal to F1=P1*A1. Likewise, fluid in the second volume 308 applies a second force (designated F2) to the second surface 302 of the piston; this second force has a magnitude F2=P2*A2. The net force applied on the piston is equal to the difference between the first force and the second force (i.e., Fnet=F1−F2), and is given mathematically by equation 1.

Fnet=F1−F2=P1*A1−P2*A2 Equation 1

A “static condition” is understood to refer to conditions when there is a net zero flow of fluid between the first volume 306 and the second volume 308; such net zero flow occurs when the first pressure (P1) of fluid in the first volume 306 is equal to the second pressure (P2) of fluid in the second volume 308. In an active suspension system, static conditions may be achieved when the pump is inactive (e.g., when the pump does not generate a pressure differential). As can be seen from equation 1, even under a static condition of the suspension component (i.e., even when P1=P2), a net force may be applied to the piston due to the difference between the first area (A1) and the second area (A2). The net static force applied to the piston 300 under static conditions of the suspension component is given by equation 2, where Pstatic=P1=P2.

Fnet,static=Pstatic*(A1−A2) Equation 2

When the suspension component is attached to the top mount assembly via the piston rod 6, the net static force (Fnet,static) applied to the piston 300 may be transferred through the piston rod 6 to the strike plate 4. Application of the net static force to the strike plate may cause the strike plate to move away from its neutral position to a loaded position. A “loaded position” of the strike plate 4 is understood to refer to the position of the strike plate 4, relative to the bracket 3, when the net static force is applied to the strike plate 4 by the rod of the suspension component under static conditions. Due to the net static force, the loaded position of the strike plate 4 may be displaced relative to the neutral position 11 of the strike plate 4. The difference between the loaded position of the strike plate 4 and the neutral position 11 of the strike plate 4 may be referred to as static displacement, and depends on the static pressure (Pstatic) of fluid in the first and second volumes. For sufficiently high static pressures, such as those utilized in active suspensions, the static displacement may lie at a point along the curve shown in FIG. 2 that is near the threshold value 200, thereby substantially limiting a range of motion of the strike plate relative to its loaded position in one direction.

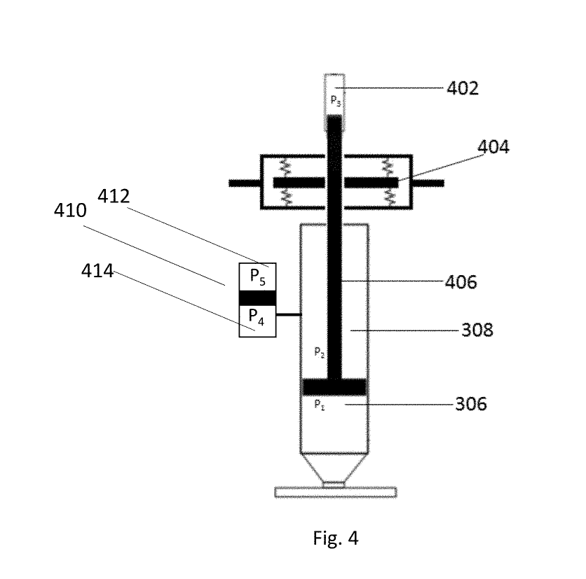

In light of the above, the inventors have recognized that, especially for active suspensions that experience high static pressures, it may be advantageous to utilize a top mount assembly configured such that static displacement of the strike plate 4 in the top mount is minimized. FIG. 4 illustrates an exemplary top mount assembly that may be configured to minimize static displacement of the strike plate 404. As illustrated, in certain embodiments the strike plate 404 and/or bracket may include an opening through which a portion of the piston rod 406 may be inserted. The piston rod 406 may be physically attached to the strike plate 404 using, for example, a fastener (e.g., a bolt). In certain embodiments, the piston rod 406 may be physically attached to the strike plate 404 via, for example, a bearing that allows the piston rod 406 to transfer linear force to the strike plate 404 while still allowing the piston rod to rotate 406 relative to the strike plate 404. Further, the suspension component may include an accumulator 410. In certain embodiments, the accumulator includes a housing that is separated, by a second piston slidably inserted into the accumulator housing, into a liquid filled volume 414 and a gas filled volume 412.

As illustrated in FIG. 4, in certain embodiments a top end of the piston rod 406 is exposed to fluid in a third volume 402 (the third volume may be part of the top mount assembly or may be directly or indirectly attached to the vehicle body). In certain embodiments, the third volume 402 contains fluid at a third pressure (P3). In certain embodiments, the third pressure may be controlled during assembly (e.g., by controlling the amount of fluid in the third volume) such that fluid in the third volume 402 may apply a third force to the top end of the piston rod that has a magnitude equal to, or similar to, the net static force but in an opposite direction. For example, the desired third pressure may be given by the equation P_{desired}=F_{desired}/A₃, where P_{desired} is the desired third pressure, F_{desired} is the desired third force for at least partially counterbalancing the net static force, and A₃ is the area of the top end of the piston rod, or the area of a body attached to the top end of the piston rod, exposed to fluid in the third volume. In certain embodiments, A₃ may equal A₁−A₂, in which case the third pressure necessary to fully counterbalance the net static force under static conditions is equal to the first pressure and the second pressure (e.g., P3=P2=P1). In other embodiments, A₃ may exceed A₁−A₂, or may be less than A1−A2, and the third pressure may be adjusted as desired in order to at least partially or fully counterbalance the net static force applied to the strike plate by the piston rod under static conditions. The third force may therefore be controlled, for example by adjusting the third pressure, to advantageously counterbalance the net static force such that static displacement of the strike plate 404 is minimized.

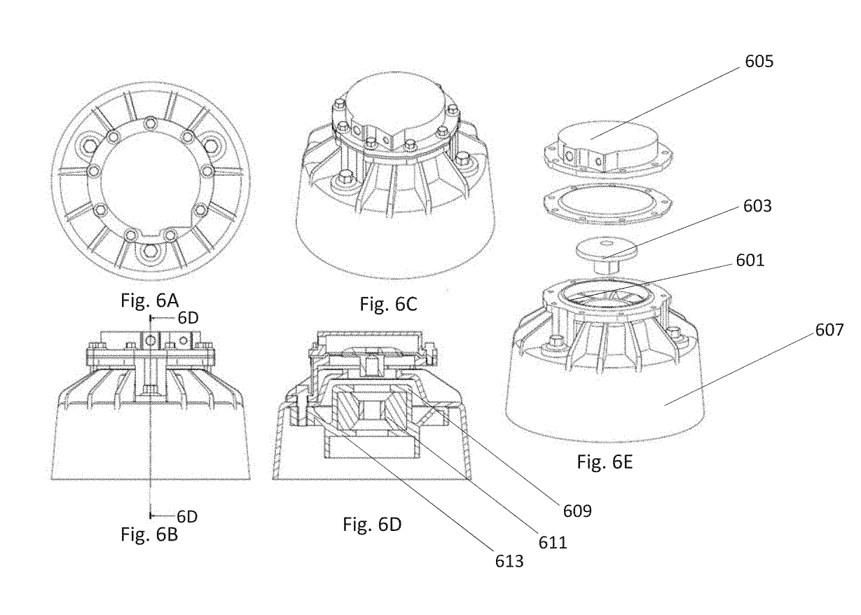

FIGS. 6A-6E illustrate an embodiment of a portion of a top mount assembly that may be used in the suspension system illustrated schematically in FIG. 4. The exemplary top mount assembly of FIGS. 6A-6E includes a diaphragm 601 having a central opening. In certain embodiments, the central opening may be sized to receive a top end of the rod. Alternatively, in certain embodiments the central opening may receive a fastener disc 603 that is configured to attach to the top end of the rod (e.g., the piston rod) of the suspension component. Such attachment may be made, for example, by a threaded nut or similar removable fastener that forms part of the fastener disc 603. Alternatively, in certain embodiments, the fastener disc may be welded, bonded, glued, or otherwise attached to the top end of the rod. In various embodiments, the diaphragm 601 and either the top end of the rod, or the diaphragm 601 and the fastener disc 603, may be sealed against an upper housing 605, such that the third volume is defined by an inner surface of the upper housing 605, a top surface of the rod or fastening disc 603, and a top surface of the diaphragm 601. The upper housing may include one or more valves or ports for filling the third volume with fluid (e.g., gas) to the desired third pressure, as described herein. Fluid in the third volume may therefore apply the third force onto the top surface of the rod or fastening disc and/or the diaphragm, and the third force may be transmitted to the rod to at least partially counterbalance the net static force. The upper housing 605 may further be configured to attach (e.g., via a flange having a plurality of openings for accepting fasteners such as, for example, bolts) to a main housing 607 that includes the top mount bracket 609. The top mount assembly may further include the strike plate 611 and the set of one or more spring elements 613 as described herein.

In certain embodiments, as shown in FIG. 4, fluid in the third volume 402 may be isolated from any other volume in the vehicle. In these embodiments, the third volume may be filled with a compressible fluid until the desired third pressure is reached. Isolation of the third volume may simplify manufacture and assembly. However, as is known in the art, pressure of a fluid may vary based on temperature of the fluid. Therefore, in embodiments in which the third volume 402 is fluidically isolated, if temperature of fluid in the third volume 402 varies significantly compared to temperature of fluid in the first volume 306, second volume 308, and/or accumulator volumes 412-414, then the third pressure of fluid in the third chamber 402 may correspondingly vary relative to pressure of fluid in the first chamber 306, second chamber 308, and/or accumulator volumes 412-414. As a result, the force applied to the rod by fluid in the third chamber may not adequately counterbalance the net static force, or, alternatively, the force applied by fluid in the third chamber may undesirably exceeds the net static force.

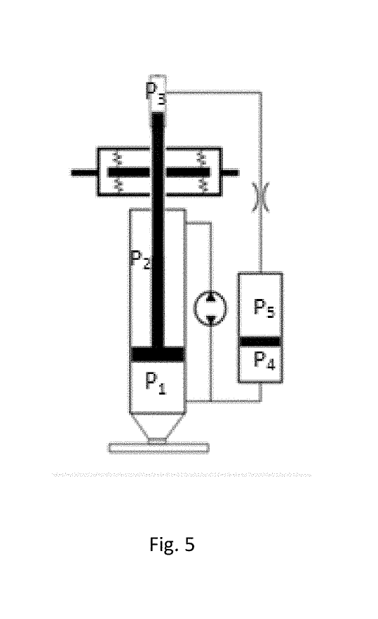

Alternatively, in certain embodiments as illustrated by the exemplary suspension system of FIG. 5, the third volume may be in fluid communication with (e.g., fluid may be transmitted between) another volume of the suspension system. By placing the third volume in fluid communication with another volume of the suspension system, the aforementioned temperature effects may be accommodated or eliminated. As illustrated in FIG. 5, in certain embodiments, the gas filled volume of the accumulator may be placed in fluid communication with the third volume. That is, fluid may be exchanged between the gas filled volume of the accumulator and the third volume.

In the illustrated embodiment, when the pump is inactive (e.g., when there is no pressure differential across the pump), the first pressure of fluid in the first volume of the suspension component may be equal to the second pressure of fluid in the second volume of the suspension component—that is, when the pump is inactive, the suspension component may be under static conditions (i.e., P1=P2=Pstatic). Since the first volume and/or second volume are in fluid communication with the liquid filled volume of the accumulator, fluid pressure in the liquid filled volume of the accumulator may equilibrate such that a fourth pressure of fluid in the liquid filled volume is equal to the first pressure and second pressure (e.g., under static conditions, P4=P1=P2=Pstatic). Further, due to the slidable nature of the piston, fluid pressure in the gas filled volume of the accumulator may equilibrate such that a fifth pressure of fluid in the gas filled volume of the accumulator is equal to the fourth pressure in the liquid filled volume of the accumulator (e.g., under static conditions, P5=P4=P1=P2) of fluid in the liquid filled volume of the accumulator. Finally, due to fluid communication between the third volume of the top mount assembly and the gas filled volume of the accumulator, fluid pressure in the third volume may equilibrate such that the third pressure of fluid in the third volume is equal to the fourth pressure of fluid in the gas filled volume of the accumulator (e.g., under static conditions, P3=P5=P4=P1=P2). Fluid in the third volume of the top mount assembly may therefore apply a force to the piston rod that fully, nearly fully, or at least partially counterbalances the net static force applied on the piston. The force applied by fluid in the third volume may dynamically vary with changes in the net static force that occur due to temperature changes of fluid in the first volume, second volume, or accumulator volumes

In certain embodiments, a tuned restriction may be located between gas filled volume of the accumulator and the third volume of the top mount. This restriction may serve to mitigate transmission of high-frequency pressure ripple from the pump into the third volume of the top mount. As used herein, high-frequency may be any predefined frequency range, for example frequencies in the range of 5-1000 Hz, 10-1000 Hz, 15-1000 Hz, or 20-1000 Hz.

Alternatively or additionally, in certain embodiments, the third volume of the top mount assembly may be in fluid communication with at least one of the first volume of the suspension component and the second volume of the suspension component. Such fluid communication from the suspension component to the third volume of the top mount may occur, for example, by a passage way that runs through the piston rod. In these embodiments, the third volume may be at least partially filled with a non-compressible fluid (e.g., oil).

In certain embodiments, the third volume of the top mount assembly may be at least partially filled with a compressible fluid (e.g., a gas) and the first volume and second volume of the suspension component may be at least partially filled with a non-compressible fluid (e.g., oil). In these embodiments, a diaphragm may be utilized to separate or effectively separate the compressible fluid (e.g., the gas) in the third volume of the top mount assembly from the non-compressible fluid (e.g., the oil) in at least one of the first volume and second volume of the suspension component. In certain embodiments, the diaphragm may be sufficiently flexible such that a change in pressure of the non-compressible fluid in at least one of the first volume and second volume of the suspension component thereby results in a similar change in pressure of the compressible fluid in the third volume of the top mount.

In certain embodiments, the third volume may be partially filled with a compressible fluid and partially filled with a non-compressible fluid. In these embodiments, a diaphragm or a piston may be utilized to separate or effectively separate the compressible fluid in the third volume from the non-compressible fluid in the third volume. In these embodiments the non-compressible fluid in the third volume may be in fluid communication with at least one of the first volume and second volume of the suspension component. Under static conditions the third volume may counteract the net static force, and the pressure of the non-compressible fluid in the third volume may be equal to or effectively equal to the pressure in at least one of the first volume and second volume of the suspension component. Furthermore, in these embodiments, a fluid restriction may be fluidly disposed between the non-compressible fluid in the third volume and at least one of the first volume and second volume of the suspension component. This restriction may serve to mitigate transmission of high-frequency pressure ripple from the first or second volume to the third volume.

What is claimed is:

1. A pressurized top mount for a vehicle, with a bracket configured to be attached to the body of the vehicle, comprising:
a chamber attached to one of the body or the bracket, configured to slidably receive an end of a piston rod of a suspension component; and
a pressurized fluid volume contained in the chamber, configured to apply a force to the end of the piston rod.

2. The pressurized top mount of claim 1, wherein the suspension component has a first component volume and a second component volume, the top mount further comprising:
an element selected from the group consisting of a diaphragm and a piston, disposed within the chamber, dividing the pressurized fluid volume into a first fluid volume and a second fluid volume, wherein the first fluid volume is at least partially filled with a compressible fluid and the second fluid volume is at least partially filled with a non-compressible fluid; and
wherein the second fluid volume is in fluid communication with at least one of the first component volume and the second component volume.

3. The pressurized top mount of claim 2, wherein the second fluid volume is in fluid communication with the first component volume.

4. The pressurized top mount of claim 2, wherein the second fluid volume is in fluid communication with the second component volume.

5. The pressurized top mount of claim 2, further comprising:
a restriction fluidly disposed between the second fluid volume and the at least one of the first component volume and the second component volume;
wherein said restriction is configured to prevent transmission of high-frequency pressure ripple from the at least one of the first component volume and the second component volume to the second fluid volume.

6. The pressurized top mount of claim 5, wherein the force applied to the end of the piston rod is configured to counteract a net static force of the piston rod.

7. The pressurized top mount of claim 1, wherein the suspension component includes an accumulator, and wherein the pressurized fluid volume is in fluid communication with the accumulator.

8. The pressurized top mount of claim 7, further comprising:
an element selected from the group consisting of a diaphragm and a piston, disposed within the chamber, dividing the pressurized fluid volume into a first fluid volume and a second fluid volume, wherein the first fluid volume is at least partially filled with a compressible fluid and the second fluid volume is at least partially filled with a non-compressible fluid; and
wherein the first fluid volume is in fluid communication with a compressible fluid volume within the accumulator.

9. The pressurized top mount of claim 8, further comprising:
a restriction fluidly disposed between the first fluid volume and the compressible fluid volume within the accumulator;
wherein said restriction is configured to prevent transmission of high-frequency pressure ripple from the compressible fluid volume within the accumulator to the first fluid volume.

10. The pressurized top mount of claim 9, wherein the force applied to the end of the piston rod is configured to counteract a net static force of the piston rod.

11. The pressurized top mount of claim 1, wherein the suspension component has a first component volume and a second component volume, the top mount further comprising:
a diaphragm fluidly disposed between the pressurized fluid volume and one of the first component volume and second component volume;
wherein the pressurized fluid volume is at least partially filled with compressible fluid.

12. The pressurized top mount of claim 11, wherein the diaphragm is a flexible diaphragm configured to allow a change in pressure in the one of the first component volume and second component volume to cause a change in pressure in the pressurized fluid volume.

13. The pressurized top mount of claim 12, wherein the force applied to the end of the piston rod is configured to counteract a net static force of the piston rod.

14. The pressurized top mount of claim 1, wherein the suspension component is an actuator of an active suspension system.

15. The pressurized top mount of claim 1, wherein the suspension component is a damper of one of a passive suspension system or a semi-active suspension system.

16. The pressurized top mount of claim 1, wherein the force applied to the end of the piston rod is configured to counteract a net static force of the piston rod.
